(19) United States
(12) Patent Application Publication
(10) Pub. No.: US 2006/0130883 A1
(43) Pub. Date: Jun. 22, 2006

(54) Closed-loop containment ash washer assembly and method

(75) Inventors: Raymond Niedzwiecki, Palo Alto, CA (US); Neil J. Bailer, Bridgeport, PA (US)

Correspondence Address: BEYER WEAVER & THOMAS LLP, P.O. BOX 70250, OAKLAND, CA, 94612-0250, US

(73) Assignee: EZ ENVIRONMENTAL SOLUTIONS CORPORATION, MENLO PARK, CA (US)

(21) Appl. No.: 11/016,532

(22) Filed: Dec. 17, 2004

(51) Int. Cl. B08B 3/02

(52) U.S. Cl. 134/94.1; 134/172; 134/182; 134/186

(57) ABSTRACT

A closed-loop containment washer assembly for use with a pressure washer apparatus for washing an object containing a medium weight contaminant. The washer assembly includes a clean wash fluid basin, and a first collection basin configured and oriented to collect the run-off of a washing fluid after being flowed over the object to remove the medium weight contaminant. A first filter assembly is included having an inlet side in fluid communication with the contaminated washing fluid collected in the basin, and an outlet side for outlet flow of filtered washing fluid. A minority portion of the outlet flow is diverted into the clean wash fluid basin, and a majority portion of the outlet flow is diverted back into the first collection basin. The majority portion is dispensed into the first collection basin in an agitating, turbulent manner to cause the collected medium weight contaminants contained therein to be or remain suspended in the collected washing fluid to promote passage into the inlet side of the filter assembly.

### BACKGROUND OF THE INVENTION

1. Field of Invention

The present invention relates generally to methods and apparatus for use in pressure washing. More particularly, the present invention relates to methods and apparatus for safely washing objects with a pressure washer apparatus, or similar device, and recovering contaminants from the objects.

2. Description of the Relevant Art

Contamination of the environment by man-made substances has long been considered a serious worldwide problem. Recently, concern about contamination of earth, air, and groundwater by oil, toxic chemicals, and other hazardous wastes has expanded beyond large-scale industry to encompass the activities of many small businesses including automobile service stations, and many others. Both government regulations and social outcry have placed tremendous pressure on these businesses to avoid discharging hazardous wastes into the environment in the course of ordinary business activities.

Many businesses partake in activities, which are likely to produce waste, which may be harmful to the environment. For example, a large portion of the painting industry uses electrostatic painting with both wet paint and powder coating. This painting process requires electric current to flow between the part to be painted and the paint that is being applied. Many commercial painting operations apply metallic based hooks from which the parts to be painted are suspended. These conductive metal hooks (generally made from steel) support both the part to be painted, and electricity that is conducted therethrough.

During the painting process, these metallic hooks are also coated with paint and, hence, require periodic cleaning to restore their ability to be conduct electricity to the part to be painted. To clean these hooks, they are typically placed into an oven where the temperature can range from 800° F.-1200° F. in order to ignite the overspray. After baking in the oven, this ignited paint (in the form of ash) must be removed from the hooks.

One typical way to dislodge the ash from the hooks is to spray them with water using high pressure washing equipment. These medium weight ash contaminants, however, often contain hazardous materials and therefore must be collected and disposed of in a proper manner. Many high-pressure washer washing equipment does not have containment capability for hazardous materials. Hence, such pressure washers may not prevent hazardous materials from entering the surrounding environment. Some pressure washers may be able to recover some washing fluid, although pressure washers which recover some washing fluid often do not filter hazardous wastes, or do not efficiently filter all hazardous wastes out of the washing fluid. As such, pressure washing systems often generate relatively large volumes of wastewater which must either be processed separately, or placed in barrels for disposal. Further, since such pressure washing systems are often required to handle large volumes of wastewater, the pressure washing systems are not readily transportable.

More recently, portable, zero-discharge wash apparatus systems have become widely available which may recover oil, chemicals, and other hazardous materials from an object, which is being washed. These closed-loop pressure wash systems may efficiently recirculate, heat, and repeatedly filter, a process fluid, thereby minimizing the quantity of waste material produced during a washing process. Typical of such systems are disclosed in U.S. Pat. Nos.: 6,120,614; 5,673,715; 5,785,067 and 5,803,982, incorporated herein by reference.

For ash based cleaning systems, a collection basin is typically provided to collect the washing fluid run-off that contains the dislodged medium weight ash. Some type of filtration system is typically employed that has a flow inlet in communication with the collected washing fluid run-off and ash contaminants collected in the collection basin. As the ash contaminant is filtered from the run-off washing fluids, the filtered washing fluids are returned into a clean wash fluid basin for reuse through the pressure washer.

While this type of closed-loop cleaning system is adequate, it is problematic in that the medium weight ash contaminant will tend to settle to the bottom of the collection basin without being drawn into the flow inlet into the filter assembly. Ash (or medium weight) contaminants typically have a specific gravity of between 0.7 and 1.3 substantially equivalent to or just greater than that of the washing fluid, which is typically water. Hence, in time, the contaminant will tend to gravitate toward the bottom of the collection basin. Therefore, while suction created at the flow inlet is sufficient to draw in the ash contaminants in the region immediately surrounding the flow inlet, it will not be sufficient to draw in the ash contaminants outside of the immediately surround region. This is especially troublesome for the medium weight contaminants that have already settled to the bottom of collection basin, and are too distant from the flow inlet to be drawn through the filter assembly. Moreover, ash contaminants will tend to absorb water and clump together over time, further decreasing the ability of suction mechanism to draw the same through the flow inlets. In these instances, the contaminate must either be manually removed or must be manually moved closer to the flow inlet to be drawn therethrough.

Accordingly, it would be desirable to provide a closed-loop cleaning system that is capable of removing a majority portion of the collected medium weight contaminants from a collection basin, while maintaining the clean fluid quality of the washing fluid in the clean fluid containment reservoir.

### SUMMARY OF THE INVENTION

The present invention relates to a closed-loop containment washer assembly for use with a pressure washer apparatus for washing an object having a medium weight contaminant. The washing assembly includes a clean wash fluid basin, and a first collection basin configured and oriented to collect the run-off of a washing fluid after being flowed over the object to remove the medium weight contaminant. A first filter assembly is included having an inlet side in fluid communication with the contaminated washing fluid collected in the basin, and an outlet side for outlet flow of filtered washing fluid. In accordance with the present invention, a first portion of the outlet flow is diverted into the clean wash fluid basin, and a second portion of the outlet flow is diverted into the first collection basin. The diverted second portion of outlet flow, into the collection basin, is directed to agitate and/or create turbulence of the collected fluids in the collection basin to cause the medium weight contaminants therein to be or remain suspended in the collected washing fluid. Consequently, passage of the medium weight contaminants into the inlet side of the filter assembly is promoted.

Accordingly, the present invention maintains or creates agitation and/or turbulence of the collected ash and collected run-off washing fluid within the collection basin to promote collection into the filter assembly. The filtered washing fluid is delivered to both the collection basin where the sump pump is located, and to the clean wash fluid basin for reuse by the pressure pump. By returning a majority portion of the filtered washing fluid back into collection basin, in the form of a stream, the returning water is applied to maintain the ash in agitation or suspension so that it will not settle before it can be collected in the filter assembly.

In one specific configuration, the first portion is a minority portion of the outlet flow, while the second portion is a majority portion of the outlet flow. An outlet nozzle portion is also included fluidly coupled to the outlet side of the filter assembly, and is configured to jettison the majority portion of outlet flow into the first collection basin in a jet stream. This jettison causes the desired agitation and turbulence. In another configuration, the outlet nozzle portion is oriented off-set from a center of the collection basin to cause rotating and agitating motion of the contaminated washing fluid collected therein.

In still another specific embodiment, a flow diversion device is included that is fluidly coupled to the outlet side of the filter assembly. The flow diversion device is configured to divert the outlet flow between the first collection basin and the clean wash fluid basin. In another arrangement, the flow diversion device is configured to divert the majority portion of the outlet flow in the range of about 53% to about 75% to the first collection basin, and the remaining minority portion of the outlet flow in the range of about 47% to about 25% to the clean wash fluid basin.

In still another aspect of the present invention, a sump pump is included that is disposed in the collection basin and fluidly coupled to the inlet side of the filter assembly. The inlet side into the sump pump is disposed proximate a central portion of the first collection basin for intake of the agitated contaminants.

In another aspect of the present invention, a closed-loop containment washer assembly is provided for use with a pressure washer apparatus. The washer assembly includes a support surface configured to support the object to be washed, and a first collection basin, a second collection basin and a clean wash fluid basin. The first collection basin is configured and oriented to collect a portion of the run-off of a washing fluid after being flowed over the object to remove the medium weight contaminant, while the second collection basin is configured and oriented to collect substantially the remaining portion of the run-off of the washing fluid after being flowed over the object to remove the medium weight contaminant. The wash assembly further includes a first filter assembly and a second filter assembly. Each filter assembly includes an inlet side in fluid communication with the contaminated washing fluid collected in the respective collection basin, and each includes an outlet side for outlet flow of respective filtered washing fluid thereof. In each of the first filter assembly and the second filter assembly, a respective minority portion of the respective outlet flow from the first filter assembly is diverted into the clean wash fluid basin, and a respective majority portion of the respective outlet flow is diverted into the respective collection basin in an agitating, turbulent manner to cause the collected medium weight contaminants contained therein to be or remain suspended in the collected washing fluid to promote passage into the respective inlet side of the respective filter assembly.

### BRIEF DESCRIPTION OF THE DRAWINGS

The method and assembly of the present invention has other objects and features of advantage which will be more readily apparent from the following description of the Detailed Description of the Embodiments and the appended claims, when taken in conjunction with the accompanying drawing, in which:

FIG. 1 is a top perspective view a closed-loop pressure washing assembly constructed in accordance with the present invention.

FIG. 2 is a top perspective view a containment assembly of the pressure washing assembly of FIG. 1.

FIG. 3 is a front elevation view of the pressure washing assembly of FIG. 1.

FIG. 4 is a side elevation view of the pressure washing assembly of FIG. 1.

FIG. 5 is a reduced top plan view of the pressure washing assembly of FIG. 1.

FIG. 6 in an enlarged top perspective view, partially cut away, of a gutter assembly and drain spout of the pressure washing assembly, taken along line 6-6 in FIG. 1.

FIG. 7 in a side elevation view, in cross-section, illustrating the gutter assembly and drain spout of FIG. 6.

FIG. 8 is a schematic diagram of the containment assembly of FIG. 2, illustrating a fluid fill mode in accordance with the present invention.

FIG. 9 is a schematic diagram of the containment assembly of FIG. 2, illustrating operation of a pressure washer apparatus with the washing assembly in accordance with the present invention.

FIG. 10 is a schematic diagram of the containment assembly of FIG. 2, illustrating an ash wash mode in accordance with the present invention.

FIG. 11 is a schematic diagram of the containment assembly of FIG. 2, illustrating a die wash mode in accordance with the present invention.

### DETAILED DESCRIPTION OF THE EMBODIMENTS

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

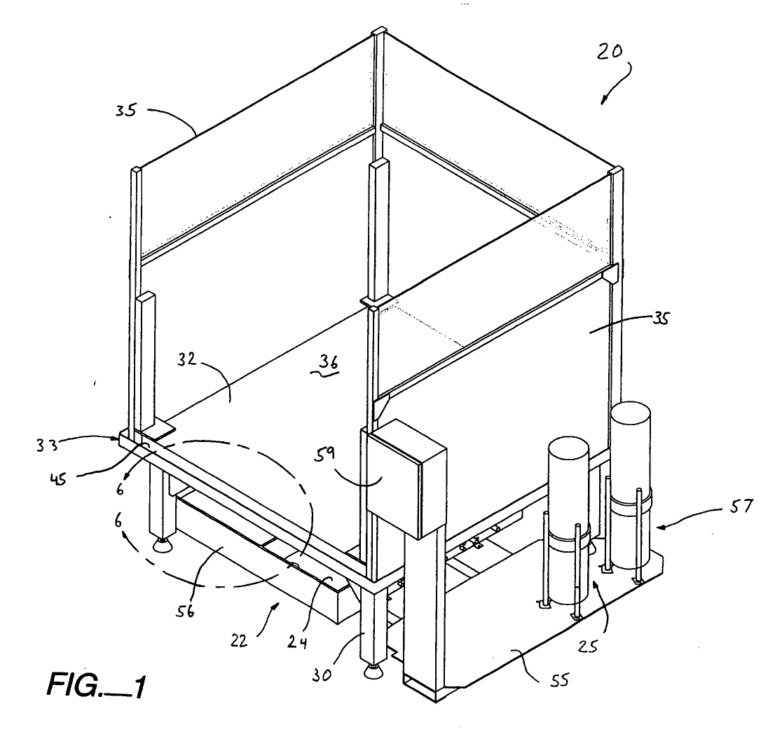

Attention is now directed to FIGS. 1, 2, 9 and 10 where a closed-loop washing assembly, generally designated 20, is illustrated for use with a pressure washer apparatus 21 for washing an object (not shown) having a medium weight contaminant such as ash. A lower fluid containment assembly 22 of the washing assembly 20 includes a clean wash fluid basin 23, and a first collection basin 24. This containment assembly is configured and oriented to collect the run-off of a washing fluid after being flowed over the object to remove the medium weight contaminant, as well as contain the filtered water once it passes through a first filter assembly 25 thereof. The filter assembly 25 is included having an inlet side 27 in fluid communication with the contaminated washing fluid collected in the collection basin 24 for access thereto. The filter assembly 25 also includes an outlet side 28 for outlet flow of filtered washing fluid once it has passed through the filter system (to be described in greater detail below).

In accordance with the present invention, a first portion of the outlet flow from the filter assembly is diverted into the clean wash fluid basin 23 for reuse through the pressure washer apparatus 21. The remaining second portion of the outlet flow is diverted into the first collection basin 24 in a manner causing agitation and/or to create turbulence of the collected fluids in the collection basin. Consequently, the medium weight contaminants therein are caused to be, or remain, suspended in the collected washing fluid so that they can be drawn into the inlet side of the filter assembly 25.

Accordingly, the present invention maintains or creates agitation and/or turbulence of the collected ash and collected run-off washing fluid within the collection basin to promote collection into the filter assembly. The filtered washing fluid is returned to the wash reservoir where the returning washing fluid is sent to both the clean wash fluid basin for reuse by the pressure pump, and also to the collection basin where the sump pump is located. By returning second portion (preferably a majority portion) of the filtered washing fluid back into collection basin, in the form of a stream, the returning water is applied to maintain the ash in agitation so that it does not settle before it can be collected in the filter bag.

Briefly, it will be understood that the term “washing fluid” is applied to a washing agent used to wash contaminants from the surface of an object. For instance, water is the most typical washing agent, but may further include cleansing additives such as detergents, soda ash, etc. Moreover, “lower-density contaminants” or “light weight contaminants” are typically referred to as contaminants with a specific gravity less than that of the washing fluid. Thus, the lightweight contaminants naturally separate and float to the surface of the collected washing fluid. Such contaminants may include oil, gasoline, foams, plastics, ash, etc. In contrast, “heavier-density contaminants” or “heavy weight contaminants” are typically referred to as contaminants with a specific gravity greater than that of the washing fluid. Finally, it will be understood that the terms “medium-density contaminants” or “medium weight contaminants” are referred to as contaminants with a specific gravity similar to that of the washing fluid, which may be suspended therein. For those medium weight contaminants that have a specific gravity slightly greater that that of the washing fluid, given ample time, will eventually settle out of the washing fluid and to the bottom of the collection basin. It is these settled medium weight contaminants that the present invention seeks to address. Such medium weight contaminants, for example, include ash.

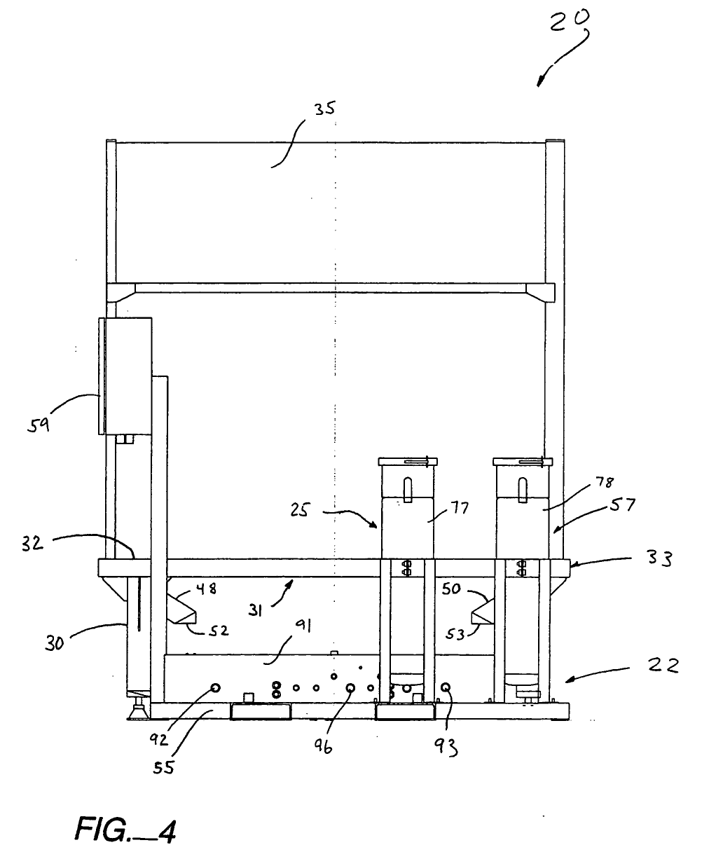

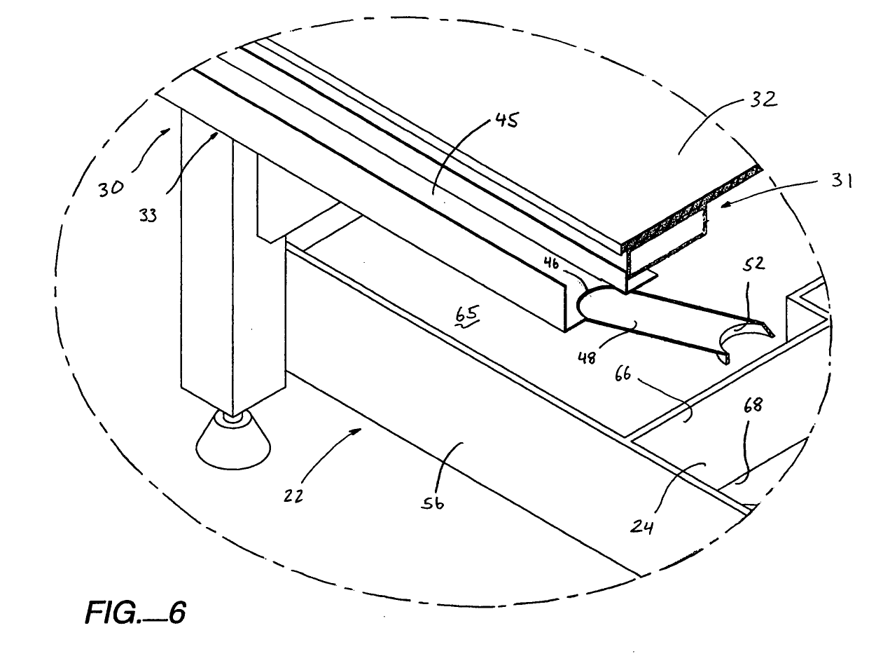

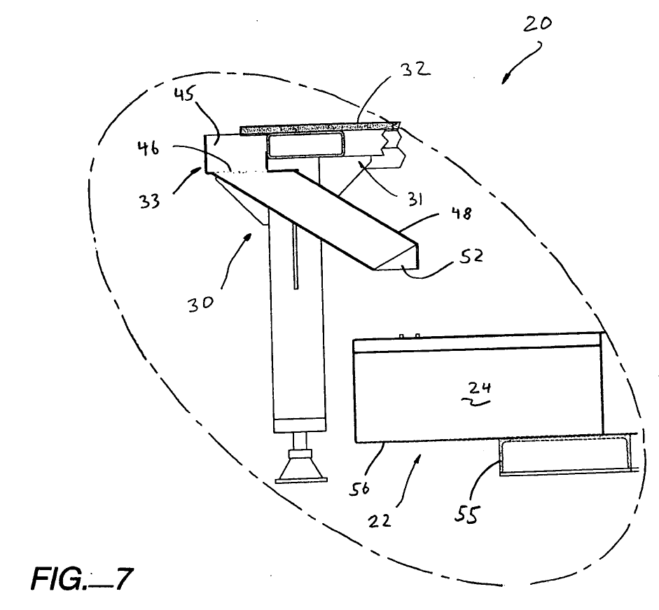

Referring generally now to FIGS. 1 and 3-7, the pressure washing assembly 20 includes a base frame 30 which is a generally rectangular structure comprising four base side frames, although it should be appreciated that base frame 30 may take on any suitable shape. The base frame 30 preferably includes an upper support frame that may include lateral beams that are joined to cross beams. This base frame is formed and dimensioned to receive and vertically support a subfloor assembly 31 that supports the object (not shown) above the containment assembly 22. This subfloor assembly 31 includes a fluid impervious support floor 32 (FIGS. 6 and 7) which directs the run-off washing fluid and contaminants into a peripheral gutter system 33 that collects and further directs the run-off into the containment assembly 22 preferably positioned below the subfloor assembly. The subfloor assembly 31 may further include an optional flex mat, or an optional metal, plastic or fiberglass grate assembly (not shown) that may be positioned atop the support floor 32 to support the object so that it does not come into direct contact therewith.

Peripherally surrounding spray walls 35 are provided that collectively define a wash bay 36. These spray walls function to contain overspray within the wash bay 36 during the washing modes.

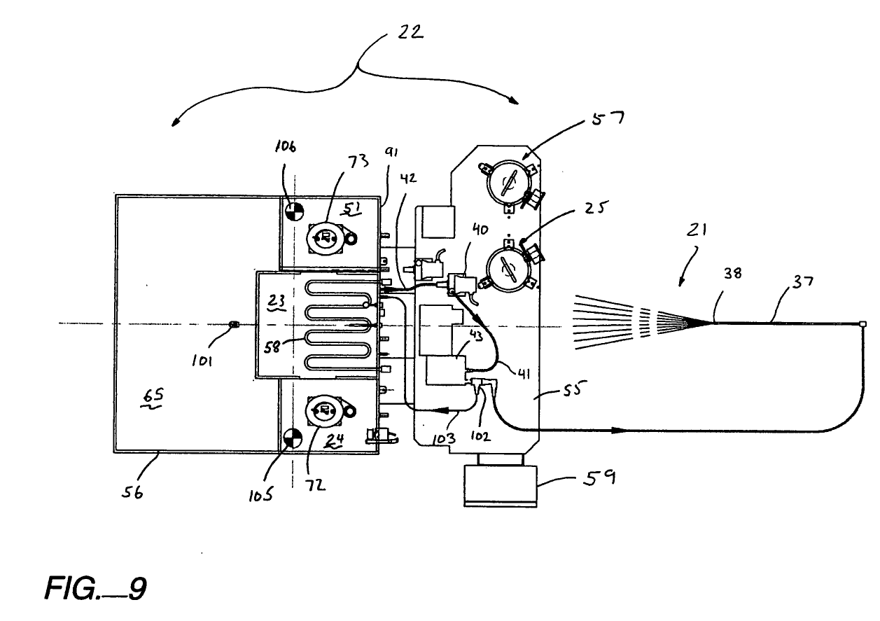

In the preferred embodiment, the containment assembly 22 is structured for use in connection with a conventional spray pressure washer apparatus 21. As shown in FIG. 9, these spray pressure washer apparatuses 21 provide a mechanism to pressure wash the object using a conventional pressure wand 37 and a compatible stainless steel spray nozzle 38. The containment assembly 22 and the spray pressure washer apparatus 21 together cooperate to form the closed-loop pressure washing assembly 20. Briefly, the pressure washer apparatus 21 is coupled to an outlet side of a supply or booster pump 40, via pump line 41, which in turn is fluidly coupled to the clean wash fluid basin 23, via pump line 42, of the containment assembly 22. A pressure pump 43 of the pressure washer apparatus 21 may be provided by any conventional high-pressure pump assembly, and is preferably capable of delivering a variable pressure for a selective pressure spray application. One such conventional pressure pump, for example, is that provided by WANNER, Model No. MD3EABJSSECA, which is capable of providing a low-pressure spray in the range of about 100 psi and a high-pressure spray in the range of about 1000 psi.

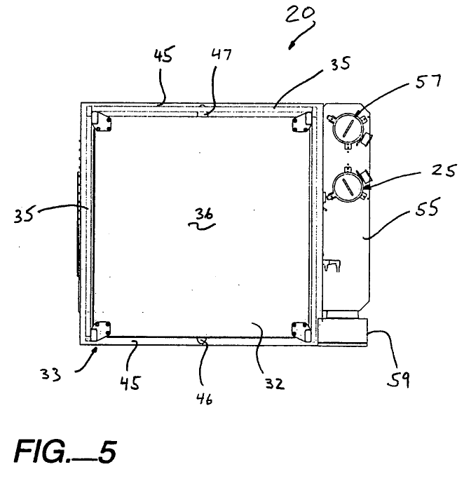

Once the object is pressure sprayed, any loose contaminants, surface oils, ash etc., from the surface of the metallic object will be removed. Subsequently, the run-off process fluid falls upon the support floor 32 of the subfloor assembly 31 wherein this run-off is directed into peripheral gutters 45 of the gutter system 33 surrounding the edges of the support floor 32. These gutters 45 then gravitationally direct the flow of the collected run-off washing fluid through a pair of opposed gutter openings 46, 47 (FIGS. 5 and 6) of the gutter 45. As best viewed in FIGS. 6 and 7, corresponding directional spouts 48, 50 positioned below the opposed gutter openings 46, 47 direct portions of the collected run-off washing fluid into the corresponding collection basins (i.e., the first collection basin 24 and an opposed second collection basin 51). A collection end of each spout 48, 50 collects the run-off pouring through the respective gutter opening 46, 47, while an opposed nozzle end 52, 53 of each respective spout 48, 50 is oriented to gravitationally dispense the run-off into the corresponding collection basin 24, 51.

To further divert the excess run-off washing fluid toward the gutter openings 46, 47, the gutters 45, the frame assembly and/or support floor can be configured to gravitationally flow the run-off thereto. For example, this may be performed by tilting the entire frame assembly and/or the gutters to gravitate the run-off process fluid toward the gutter openings 46, 47. Another technique is to bow central portion of the support floor 32 or to gravitationally direct the run-off toward the gutters or gutter openings.

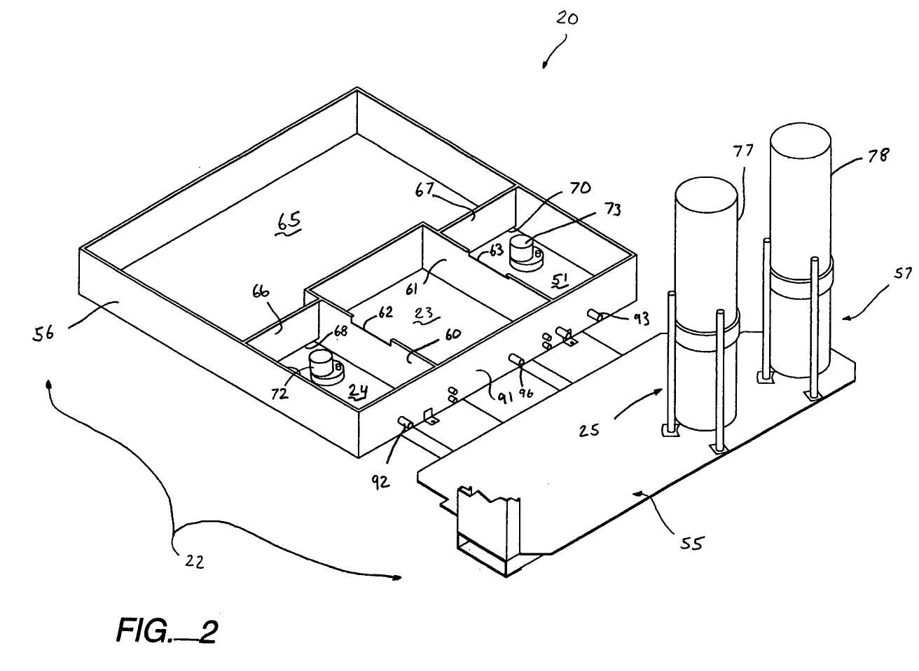

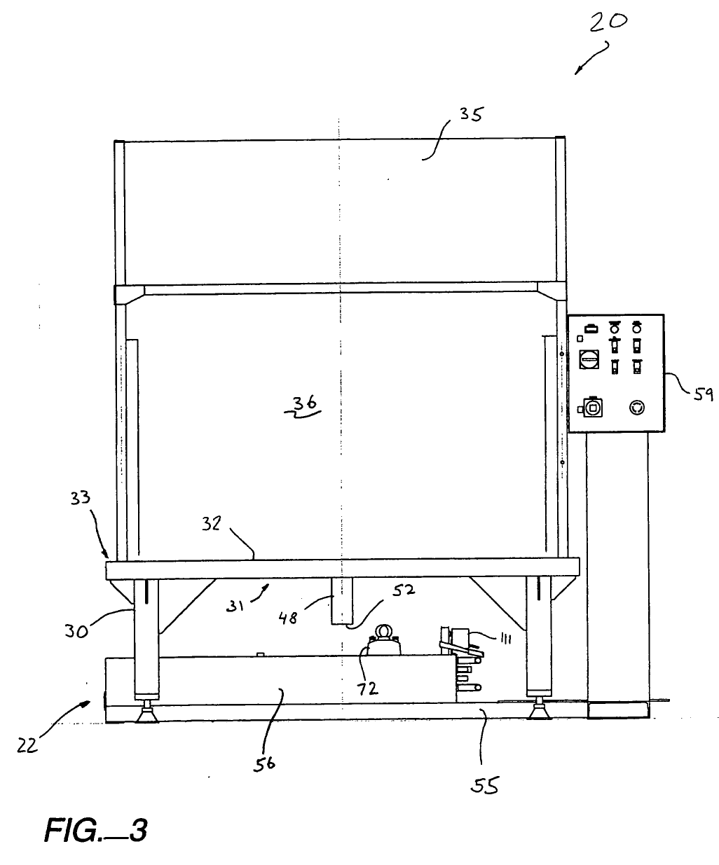

Referring back to FIGS. 2 and 3, the containment assembly 22 is now described in detail. The containment assembly 22 preferably includes a support housing or platform 55 that contains the necessary filter assemblies, plumbing, motors, pumps, etc. to operate the containment assembly 22 and provide filtered process fluid to the pressure washer apparatus 21. Upstanding from the support platform 55 is a control unit 59 that enables control of all operation wash assembly 20.

The containment assembly 22 further includes compartmentalized tub unit 56 which define the distribution and collection of washing fluids. Preferably, the tub is rectangular and low profile which enables the subfloor assembly 31 to be rolled out over the tub unit 56 of the containment assembly 22 on rollers or the like (not shown) that may be provided at the ends of the support legs.

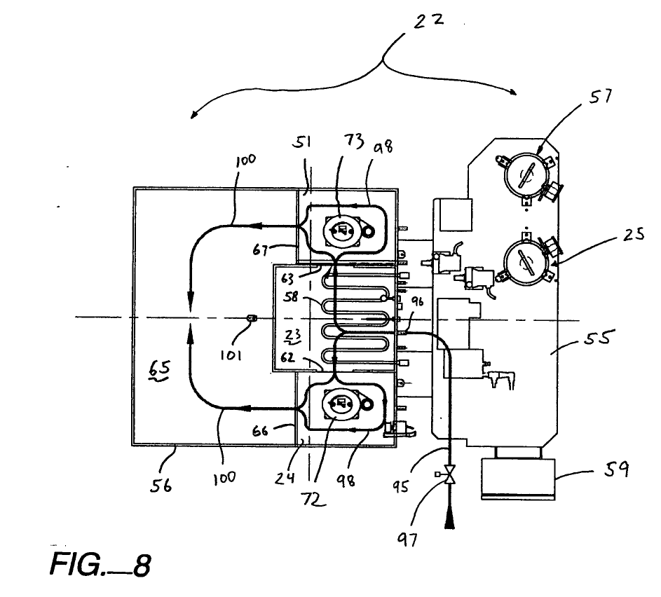

On one end of the tub unit 56 is a rectangular-shaped central clean wash fluid basin 23 that is reserved for the disposition of clean and/or filtered washing fluid. During a fill sequence, clean wash fluid may be dispensed directly into this basin 25. This containment region also serves as the reservoir for the minority portion of the filtered wash fluid dispensed from the first and second filter assemblies 25, 57. As mentioned, the reservoir feeds clean washing fluid directly to the pressure washer via pump lines 41, 42 and booster pump 40. FIGS. 8-11 further illustrate that the containment assembly 22 may include a conventional heating coil or element 58 that is disposed in the clean wash fluid basin 23. Using such a heating element 58, the filtered wash fluid can be heated to a substantially high temperature in the range of about 80° F. to about 212° F., and more preferably in the range of about 140° F. to about 160° F.

As best viewed in FIG. 2, on opposed sides of the clean wash fluid basin 23 is the first collection basin 24 and an opposed second collection basin 51. A common sidewall 60, 61, separates each basin from the fluid basin 23. As above indicated, when the subfloor assembly 31 is properly positioned over the tub unit 56 of the containment assembly, the nozzle ends 52, 53 of the opposed water spouts 48, 50 of the gutter system 33 direct the collected run-off washing fluids into the respective first and second collection basins 22, 51. Accordingly, all the run-off washing fluid that contains the contaminants (i.e., ash medium-weight contaminants) is collected in one of these two opposed collection basins.

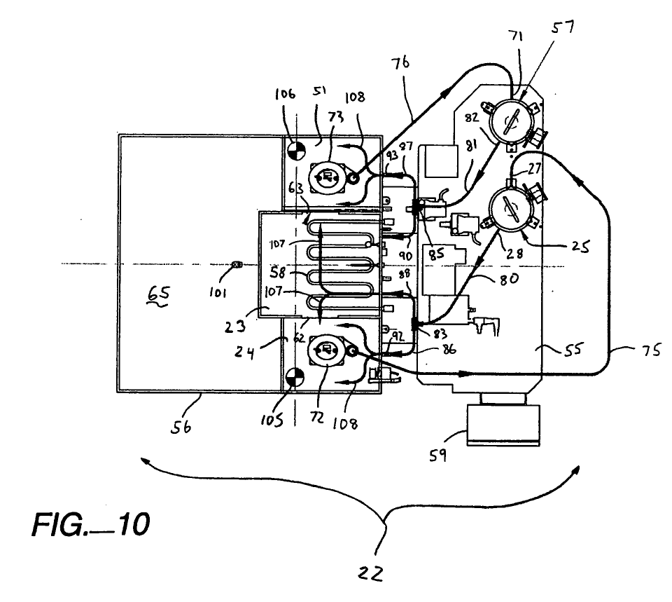

Each clean basin sidewall 60, 61 separating the clean wash fluid basin 23 from the adjacent collection basin 24, 51 include a respective over weir 62, 63. This provides an overflow path for excess washing fluid contained in the clean wash fluid basin 23 to flow into the corresponding adjacent collection basins 22, 51. Briefly, during a fill mode (FIG. 8), clean wash fluid dispensed directly into the clean wash fluid basin will be contained until the basin is at capacity. Similarly, during a wash operation (FIGS. 9 and 10), the minority portion of the filtered wash fluid from the filter assemblies 25, 57, may fill the clean wash fluid basin 23 at a greater rate than what is being drawn through the pressure washer apparatus 21. Hence, when capacity of the clean wash fluid basin 23 is reached, the excess wash fluid will flow (in the direction of arrows 98 in FIG. 9) over these over weirs 62, 63 and into the adjacent collection basins 22, 51.

Separating the pair of opposed collection basins 22, 51 from a large washing fluid reservoir 65 is a pair of corresponding collection basin rear walls 66, 67 or ash dams. The washing fluid reservoir 65 provides a primary source of washing fluid that may be quickly tapped. During operation of the system, a significant proportion of the washing fluids, relative the collective volumes contained in the collection basins 22, 51 and the clean wash fluid basin 23, are dispersed and being applied in the wash bay 36 to pressure wash an object. Moreover, a certain amount of wash fluids are normally lost due to overspray and evaporation. Accordingly, the washing fluid reservoir 65 provides an excess reservoir of wash fluid that may be drawn from during operation.

Fluid communication between the respective collection basin 24, 51 and the wash fluid reservoir 65 is provided by corresponding under weirs 68, 70 formed between the respective collection basin rear walls 66, 67 and the floor of the tub unit 56. Preferably, about an inch gap is formed therebetween for fluid communication. These under weirs 68, 70 enable such reservoir fluids to be drawn from or replenished during the wash operation, or during a fluid fill mode. Again, such operation will be described in greater detailed below.

In accordance with the present invention, each collection basin 24, 51 is fluidly coupled to a corresponding filter assembly (i.e., the first filter assembly 25 for the first collection basin 24 and the second filter assembly 57 for the second collection basin 51) for filtering the corresponding collected washing fluid contained therein. It will be appreciated, however, that both collection basins 22, 51 could be fluidly coupled to a single filter assembly, or that all the collected run-off wash fluid could be directed to a single collection basin with a single filter assembly without departing from the true spirit and nature of the present invention.

For each filter assembly 25, 57, the respective fluid inlet side 27, 71 is fluidly coupled to a corresponding sump pump 72, 73 disposed in the respective collection basin 24, 51. These sump pumps are employed to pump the collected washing fluids through the corresponding filter assemblies. Preferably, each sump pump is positioned central to the respective collection basin 24, 51, a location that maximizes their ability to drawing the collected washing fluid and ash through an sump pump intake.

These sump pumps 72, 73 can be configured to automatically operate during the operation of the pressure washer. Depending upon the quantity or flow volume of the run-off washing fluids into the collection basins 22, 51 from the support floor 32, the pumping capacity of the sump pumps 72, 73 can be selected accordingly. Moreover, these units must be capable of passing solid particles, such as ash, on a continual basis in order to pump them through the respective filter assembly 25, 57. In one specific example, the sump pumps 72, 73 may be provided by BJM Corporation of Old Saybrook, Conn., Model No. 100 that have a pump capacity in the range of about 12 gal/min to about 20 gal/min, and a maximum pressure output in the range of about 10-11 psi.

A respective pump line or hose 75, 76 (having arrows indicating the flow direction in FIG. 10) fluidly couples the corresponding sump pump 72, 73 to the inlet side 27, 71 of the respective filter assembly 25, 57. Once the sump pumps 72, 73 deliver the collected run-off washing fluid to the filter assemblies 25, 57, the medium weight and lightweight contaminants suspended in the run-off washing fluids are filtered out. In one specific configuration, these filter assemblies 25, 57 may be provided by filter canisters having an 8″×30″ filter housing 77, 78. Disposed within the housing is a 10-50 micron polypropylene filter bag. These filters may include, but are not limited to, string-wound, pleated cellulose, or polypropylene filter cartridges. Examples of such filters are those commercially available from Met Pro Corporation, Keystone Filter Division, Hatfield, Pa., USA.

It will be appreciated, however, that many other conventional filter assemblies may be employed as well without departing from the true spirit and nature of the present invention. For example, a succession of micron filters may be used to remove successively smaller particulates and molecules from the process fluid. A first filter may be deployed in the range of approximately a 100 micron filter to approximately a 150 micron filter series, which is coupled to a string-wound filter that is in the approximate range of a 30 micron to a 100 micron string-wound filter series that is, in turn, coupled to approximately a 10 micron to 30 micron polypropylene filter. The filters may generally be arranged to perform coalescing filtration by routing unfiltered water into the center of the filter, and drawing filtered water out the sides of the filter, similar to a conventional automotive oil filter.

A pressure switch (not shown), in one embodiment, is positioned along each pump line 75, 76 to measure the respective back pressure along the inlet side of the respective filter assembly. Such pressure measurements can be applied to predict the remaining filter capacity, or whether the filter mush be replaced. For example, using the sump pumps above-mentioned, the filters would likely require changing when measurements in the range of 9-10 psi are detected.

In accordance with the present invention, the fluid flow of the filtered washing fluid from each filter assembly 25, 57 is divided between the clean wash fluid basin 23 and the respective collection basin 24, 51. To create this division, a flow diversion device 83, 85 is placed in-line with a respective pump-line or hose 80, 81 (having arrows indicating the flow direction) that is fluidly coupled to the corresponding outlet side 28, 82 the of each filter assembly 25, 57. These flow diversion devices thereby divert a majority portion of the fluid flow to the respective collection basin 24, 51 (via pump lines 86, 87) while the remaining minority portion of the fluid flow is diverted toward the clean wash fluid basin (via pump lines 88, 90).

In one specific embodiment, the flow diversion device is provided by a Y-joint or T-joint fitting that is configured to divert the majority portion of the outlet flow, in the range of about 53% to about 75%, to the collection basins 22, 51, and the remaining minority portion of the outlet flow, in the range of about 47% to about 25%, to the clean wash fluid basin 23. More preferably, the majority portion of each outlet flow is in the range of about 60% to the respective collection basins 22, 51, and the remaining minority portion of each outlet flow in the range of about 40% to the clean wash fluid basin 23.

In accordance with the present invention, the majority portion of the fluid flow is jettisoned into the corresponding collection basin 24, 51 with sufficient force to generate the desired agitation and turbulence of the medium weight contaminants collected in the corresponding collection basins. On the wall front wall 91 defining a portion of the collection basins 22, 51 is an outlet nozzle 92, 93 fluidly coupled to each respective pump-line 86, 87. To generate the proper ejection characteristics from each outlet nozzle 92, 93 necessary to cause agitation and turbulence of the ash collected in each collection basin 24, 51, several primary factors must be controlled or manipulated. These factors include the viscosity of the wash fluid, the rate of flow into the collection basin and collective volume of wash fluid contained in each collection basin 24, 51. For a collective volume of wash fluid, having a viscosity similar to water, in the range of 6 gallons to about 12 gallons, it has been determined that a flow rate of about 9 gal/min to about 18 gal/min is sufficient to create the desired agitation and turbulence to maintain the medium weight contaminants in suspension.

In one specific embodiment, to generate the desired flow rate characteristics from the outlet nozzle 92, 93 into the respective collection basins 22, 51, the back pressure from the sump pump 72, 73 and the outlet diameter of the outlet nozzle 92, 93 can be adjusted. For example, with a back pressure in the range of about 3 psi to about 9 psi, and an outlet diameter of the outlet nozzle in the range of about ⅛ inch to about ½ inch, an ejection velocity in the range of about 5 ft/sec to about 13 ft/sec is created (i.e., having a flow rate in the range of about 6 gal/min to about 15 gal/min).

In another specific configuration, to generate the desired agitation and turbulence, the outlet nozzle 92, 93 can be strategically aimed, positioned and/or placed within the collection basin. Although the nozzle outlets are only represented ejecting the fluid flow toward a central portion of the respective collection basin 24, 51, the outputs can be angularly aimed, aimed downward toward the bottom of the collection basin, and/or positioned off-set from the central portion thereof. In some configurations, the outlet flow can be employed to generate a swirling flow about the respective sump pump.

Referring now to FIGS. 8-11, the operational mode of the present invention will now be described in detail. In particular, during a fill operation (FIG. 8), as briefly mentioned above, a fill line or hose 95 is fluidly coupled to a fill inlet 96 through front wall 91, and into the clean wash fluid basin 23. A solenoid valve 97 can be manually or automatically operated to open during an initial filling mode, or when fluid replenishing is necessary due to a sufficient loss of washing fluid.

As indicated by the schematic diagram of FIG. 8, once the clean wash fluid basin 23 is filled to capacity, the clean wash fluid flows over the over weirs 62, 63 and into their respective collection basins 22, 51 (indicated by arrows 98). Once the clean wash fluid flows into the collection basins, portions of the wash fluids in the collection basins 22, 51 pass under the under weirs 68, 70 created by the ash dams 66, 67, and flow into the wash fluid reservoir 65 (indicated by arrows 100). The fill operation will continue until the wash fluid level in the wash fluid reservoir 65 reaches a predetermined level. In one embodiment, a float switch 101 is disposed in the wash fluid reservoir that will control the operation of the fill solenoid valve 97 once the desired level is detected.

It will be appreciated, however, that at no time will the opposed collection basins 22, 51 be filled to capacity were the collected run-off wash fluids will flow over the over weirs 62, 63 and into the clean wash fluid basin 23. This is assured by the placement of the under weirs 68, 70.

Turning now to FIG. 9, a pressure wash operation will be described. As mentioned, the pressure washer apparatus 21 accesses the filtered wash fluid contained in the clean wash fluid basin 23, via pump line 42. A booster pump 40 initially supplies the primary pressure pump 43 of the pressure washer apparatus 21, via pump line 41. An unloader valve 102 supplies the pressurized wash fluid to the spray wand 37 that, in turn, delivers the pressurized spray of wash fluid to the wash bay 36 and the object to be washed. When the spray wand 37 is not in use, the unloader valve 102 delivers the pressurized wash fluid back into the clean wash fluid basin 23, via return line 103.

During an Ash Wash operation, as viewed in FIG. 10, the run-off wash fluid from the wash bay 36 is collected in the gutter system 33, as above indicated. As the respective run-off portions flow through the gutter openings 46, 47 and into the respective spouts 48, 50, the collected wash fluid and contaminants are delivered into the respective collection basins 22, 51 proximate to the delivery regions 105, 106 designated in the schematic diagram of FIG. 10. As the respective sump pumps 72, 73 operate, the collected wash fluids and medium weight contaminants are delivered to the inlet sides 27, 71 of the respective filter assemblies 25, 57, via pump lines 75, 76.

As the delivered wash fluids are filtered through the respective filter assemblies 25, 57, they are passed out of the filter assemblies through respective outlet sides 28, 82 thereof. Respective pump lines 80, 81 fluidly couple the outlet sides 28, 82 to the corresponding fluid diversion devices 83, 85 which divide the fluid flow between the clean wash fluid basin 23 and the corresponding collection basins 22, 51.

A minority portion of the filtered wash fluid is distributed, via diversion devices 83, 85 and pump lines 88, 90, to the clean wash fluid basin as indicated by flow arrows 107. Once the clean wash fluid basin 23 is filled to capacity, it over flows, via over weirs 62, 63, back into the respective collection basins 22, 51.

In a similar manner, the majority portion of the filtered wash fluid is distributed, via diversion devices 83, 85 and pump lines 86, 87, to the respective collection basins 22, 51 clean wash fluid basin as indicated by flow arrows 108. In accordance with the present invention, the majority portions of the filtered wash fluids are jettisoned from the respective outlet nozzles 92, 93, and into the collection basins 22, 51 in a manner causing sufficient agitation and turbulence in the collected wash fluids to maintain the medium weight contaminants in suspension to promote removal.

It will be appreciated that during this wash mode, when filtered washing fluid is not being drawn by the pressure washer apparatus 21, via booster pump 40, the sump pumps 72, 73 and filter assemblies 25, 57 may continue to operate and process the collected washing fluids for continual cleansing of the collected wash fluids.

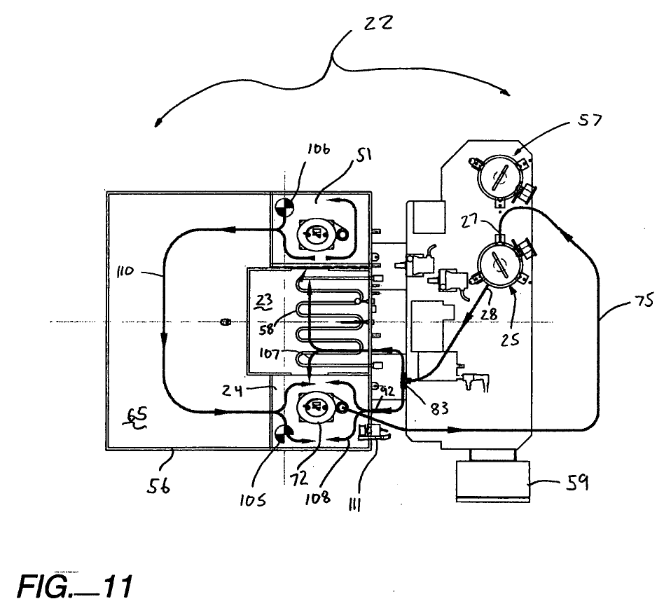

In another aspect of the present invention, referring now to FIG. 11, the closed-loop washing apparatus may also be applied in a manner similar to that described in our U.S. Pat. Nos. 6,120,614 and 6,402,855, incorporated herein by reference in their entirety. When operating in this manner, only the first filter assembly 25 will be in operating, while the second filter assembly 57 is unused. As shown in FIG. 11, the filter operation of the first filter assembly 25 functions in a manner similar to that in the wash mode of FIG. 10.

The primary difference in this mode of operations, however, is that the deposition of the collected run-off fluids in the second collection basin 51, are not drawn through the second filter assembly 57. Rather, the collected run-off from the second collection basin 51 flows under the second under weir 70, along the path or arrow 110 in a slow manner due to the operation of the first filter assembly 25. The fluid flow then is drawn through the first under weir 68, and into the first filter assembly, via sump pump 72.

In this wash mode, an oil skimmer 111 that is placed in the corner of first collection basin 24 can be operated to remove any oils moved into therein.

1. A closed-loop containment washer assembly for use with a pressure washer: apparatus for washing an object containing a medium weight contaminant comprising:
a clean wash fluid basin;
a first collection basin configured and oriented to collect the run-off of a washing fluid after being flowed over the object to remove the medium weight contaminant; and
a first filter assembly having an inlet side in fluid communication with the contaminated washing fluid collected in said basin, and an outlet side for outlet flow of filtered washing fluid;
wherein a first portion of the outlet flow is diverted into said clean wash fluid basin, and a second portion of the outlet flow is diverted into said first collection basin in an agitating, turbulent manner to cause the collected medium weight contaminants contained therein to be or remain suspended in the collected washing fluid to promote passage into the inlet side of the filter assembly.

2. The containment assembly as defined in claim 1, further including
an outlet nozzle portion fluidly coupled to said outlet side of the filter assembly, and configured to jettison the majority portion of outlet flow into said first collection basin in a jet stream to cause said agitating, turbulent manner.

3. The containment assembly as defined in claim 1, wherein,
the first portion is a minority portion of the outlet flow, and the second portion is a majority portion of the outlet flow.

4. The containment assembly as defined in claim 3, further including:
a flow diversion device fluidly coupled to said outlet side of the filter assembly, said flow diversion device being configured to divert the outlet flow between the first collection basin and the clean wash fluid basin.

5. The containment assembly as defined in claim 4, wherein
said flow diversion device is configured to divert the majority portion of the outlet flow in the range of about 53 % to about 75% to the first collection basin, and the remaining minority portion of the outlet flow in the range of about 47% to about 25% to the clean wash fluid basin.

6. The containment assembly as defined in claim 5, wherein
said flow diversion device is configured to divert the majority portion of the outlet flow in the range of about 60% to the first collection basin, and the remaining minority portion of the outlet flow in the range of about 40% to the clean wash fluid basin.

7. The containment assembly as defined in claim 1, further including:
a sump pump coupled disposed in said collection basin and fluidly coupled to the inlet side of the filter assembly.

8. The containment assembly as defined in claim 7, wherein
a flow inlet to the sump pump is disposed proximate a central portion of the first collection basin.

9. The containment assembly as defined in claim 1 wherein,
said first filter assembly includes a canister filter.

10. The containment assembly as defined in claim 1 further including:
an ozonator coupled to dispense ozonated driving fluid into the contaminated washing fluid contained in the collection basin.

11. The containment assembly as defined in claim 1 further including:
a second collection basin configured and oriented to collect a portion of the run-off of a washing fluid after being flowed over the object to remove the medium weight contaminant;
a second filter assembly having an inlet side in fluid communication with the contaminated washing fluid collected in said second collection basin, and an outlet side for outlet flow of filtered washing fluid;
wherein a minority portion of the outlet flow is diverted into said clean wash fluid basin, and a majority portion of the outlet flow is diverted into said second collection basin in an agitating, turbulent manner to cause the collected medium weight contaminants contained therein to be or remain suspended in the collected washing fluid to promote passage into the inlet side of the second filter assembly.

12. A closed-loop containment washer assembly for use with a pressure washer apparatus for washing an object containing a medium weight contaminant comprising:
a support surface configured to support the object to be washed;
a first collection basin configured and oriented to collect a portion of the run-off of a washing fluid after being flowed over the object to remove the medium weight contaminant;
a second collection basin configured and oriented to collect substantially the remaining portion of the run-off of said washing fluid after being flowed over the object to remove the medium weight contaminant;
a first filter assembly having an inlet side in fluid communication with the contaminated washing fluid collected in said first collection basin, and an outlet side for outlet flow of respective filtered washing fluid thereof;
a second filter assembly having an inlet side in fluid communication with the contaminated washing fluid collected in said second collection basin, and an outlet side for outlet flow of respective filtered washing fluid thereof; and
a clean wash fluid basin;
wherein a minority portion of the respective outlet flow from the first filter assembly is diverted into said clean wash fluid basin, and a majority portion of the respective outlet flow is diverted into said first collection basin in an agitating, turbulent manner to cause the collected medium weight contaminants contained therein to be or remain suspended in the collected washing fluid to promote passage into the respective inlet side of the first filter assembly; and
wherein a minority portion of the respective outlet flow from the second filter assembly is diverted into said clean wash fluid basin, and a majority portion of the respective outlet flow is diverted into said second collection basin in an agitating, turbulent manner to cause the collected medium weight contaminants contained therein to be or remain suspended in the collected washing fluid to promote passage into the respective inlet side of the second filter assembly.

13. The containment assembly as defined in claim 12, wherein
said support surface is configured to direct said portion of the run-off washing fluid into said first collection basin, and further configured to direct said remaining portion of the run-off washing fluid into said second collection basin.

14. The containment assembly as defined in claim 13, wherein
said support surface includes a first drain portion directing flow of said portion of the run-off washing fluid from one side of said support surface into said first collection basin, and a second drain portion directing flow of said remaining portion of the run-off washing fluid from a second side of said support surface into said second collection basin.

15. The containment assembly as defined in claim 14, wherein
said first collection basin is disposed on one side of the clean wash fluid basin, and said second collection basin is disposed on an opposite side of the clean wash fluid basin.

16. The containment assembly as defined in claim 12, further including
a first outlet nozzle portion fluidly coupled to said outlet side of the first filter assembly, and configured to jettison the majority portion of outlet flow from said first filter assembly into said first collection basin in a jet stream to cause said agitating, turbulent manner; and
a second outlet nozzle portion fluidly coupled to said outlet side of the second filter assembly, and configured to jettison the majority portion of outlet flow from said second filter assembly into said second collection basin in a jet stream to cause said agitating, turbulent manner.

17. The containment assembly as defined in claim 12, wherein,
said first outlet nozzle portion is oriented off-set from a center of the first collection basin to cause rotating agitating motion of the contaminated washing fluid collected therein, and
said second outlet nozzle portion is oriented off-set from a center of the second collection basin to cause rotating agitating motion of the contaminated washing fluid collected therein.

18. The containment assembly as defined in claim 12, further including:
a first flow diversion device fluidly coupled to said outlet side of the first filter assembly, said first flow diversion device being configured to divert the outlet flow between the first collection basin and the clean wash fluid basin; and
a second flow diversion device fluidly coupled to said outlet side of the second filter assembly, said second flow diversion device being configured to divert the outlet flow between the second collection basin and the clean wash fluid basin.

19. The containment assembly as defined in claim 18, wherein
said first and second flow diversion devices are each configured to divert the majority portion of their respective outlet flows in the range of about 55% to about 80% to the first and second collection basins, respectively, and remaining portions of their respective outlet flows in the range of about 45% to about 20% to the clean wash fluid basin.

20. The containment assembly as defined in claim 19, wherein
said first and second flow diversion devices each configured to divert the majority portion of the respective outlet flows in the range of about 60% to the first and second collection basins, respectively, and the respective remaining portions of the respective outlet flows in the range of about 40% to the clean wash fluid basin.

21. The containment assembly as defined in claim 12, further including:
a first sump pump coupled disposed in said first collection basin and fluidly coupled to the inlet side of the first filter assembly; and
a second sump pump coupled disposed in said second collection basin and fluidly coupled to the inlet side of the second filter assembly.
